(19) United States
(12) Patent Application Publication
(10) Pub. No.: US 2026/0186177 A1
(43) Pub. Date: Jul. 2, 2026

(54) HIGH LUMINANCE INTEGRATING SPHERE COMPATIBLE WITH A VACUUM OR AMBIENT ENVIRONMENT

(71) Applicant: THALES, Meudon (FR)

(72) Inventors: Maxime Meynard, CANNES LA BOCCA (FR); Arnaud Bayle, CANNES LA BOCCA (FR); Xavier Joffrin, CANNES LA BOCCA (FR)

(21) Appl. No.: 19/427,419

(22) Filed: Dec. 19, 2025

(30) Foreign Application Priority Data
Dec. 27, 2024 (FR) 24 15311

(51) Int. Cl. G02B 5/02

(52) U.S. Cl. CPC G02B 5/0205

(57) ABSTRACT

The disclosure relates to an integrating sphere having a body delimiting an integration chamber and being provided with at least two access windows to the integration chamber from the outside of the body. The body of the integrating sphere includes at least one cooling channel for the circulation of a heat transfer fluid.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure relates to a high luminance integrating sphere usable in ambient air or in a vacuum chamber.

### Description of the Related Technology

An integrating sphere, also known as an Ulbricht sphere, is an optical component consisting of a chamber or integration cavity with its interior surface covered with a coating that has a high diffuse reflection factor for the wavelengths of interest. The sphere also comprises relatively small input and output ports as compared to the dimensions of the integration chamber. Most often, the integration chamber has a spherical shape, so that light beams from any point on the internal surface of the integration chamber are distributed equally to all other points of the sphere, regardless of the original direction of the light, due to the multiple diffuse reflections they undergo.

Thus, an integrating sphere may be thought of as a diffuser which preserves power but destroys spatial information. Integrating spheres are used either as a light source or as a system for measuring the optical power of a light source.

### SUMMARY

To achieve certain objectives of the present disclosure, aspects of this disclosure relate to an integrating sphere comprising a body delimiting an integration chamber and being provided with at least two access windows to the integration chamber from outside the body, where the body comprises at least one cooling channel for the circulation of a heat transfer fluid.

The implementation of a cooling channel within the body of the integrating sphere enables good temperature control and, more particularly, effectively evacuating the heat generated by the light sources placed inside the integration chamber.

According to one optional feature, the body comprises at least two complementary half-bodies, each comprising a part of the integration chamber, and at least one cooling channel.

This embodiment enables facilitating the assembly and maintenance of the integrating sphere, for coating the internal surface of the integration chamber in particular.

According to another optional feature, a cooling channel extends inside the body over at least part of the periphery of the integration chamber.

The position of a part of the cooling channel in the immediate vicinity of the internal surface of the integration chamber enables optimizing thermal exchanges with the latter.

According to yet another optional feature, the body of the integrating sphere comprises at least one cooling chamber that is connected to the cooling channel, which extends over at least part of the periphery of the integration chamber.

The implementation of this a cooling chamber at the periphery of the integration chamber contributes to increasing the contact surface between the heat transfer fluid and the wall delimiting the integration chamber.

According to a variant of this feature, the cooling chamber defines a double-skin type of structure with a wall of the integration chamber.

According to another variant of this feature, the cooling chamber comprises at least one structure, permeable to the heat transfer fluid, connecting two opposite internal faces of the cooling chamber.

The implementation of the permeable structure connecting the two opposite internal faces of the cooling chamber enables increasing the contact surface between the heat transfer fluid and the body of the integrating sphere according to the disclosure.

In this variant, the permeable structure can be made in any appropriate way, such as in the form of fins defining a labyrinth for the circulation of the heat transfer fluid, or in the form of a mesh or porous structure, permeable to the heat transfer fluid.

According to an optional feature, the integration chamber is partially gas-tight.

According to another optional feature, the sphere comprises at least one channel for managing the internal atmosphere of the integration chamber.

The ability to control the nature of the internal atmosphere of the integration chamber enables reducing the hygrometry thereof and, in particular, being able to lower the temperature below the dew point when the sphere is used in the air.

According to an optional feature, the body of the integrating sphere is made of a thermally conductive material.

According to a preferred embodiment, the body of the integrating sphere is manufactured by additive manufacturing.

According to another optional feature, one of the windows of the integrating sphere is intended for the installation of a light source, and the body at this window comprises a base for mounting a socket for a lamp constituting the light source.

The presence of this mounting base on the body of the integrating sphere enables facilitating the installation and maintenance of light sources.

According to a variant of this feature, the integrating sphere comprises a lamp socket, this socket being adapted removably to the mounting base.

According to another variant of this feature, the socket comprises a body comprising at least two connection blocks each intended to receive a power pin of the lamp.

According to a preferred embodiment of this variant, each connection block comprises a connection channel intended to receive a power pin of the lamp and equipped with a clamping jaw of the pin controlled in the clamping position by a spring complemented by a pressure screw, adapted to reversibly immobilize the jaw in the clamping position of the power pin.

According to another variant of this feature, the body of the socket is made of a thermally conductive and electrically insulating material.

The various features, variants and embodiments can be combined with each other in various combinations, as long as they are compatible with each other.

### BRIEF DESCRIPTION OF THE DRAWINGS

Furthermore, various other features of the disclosure emerge from the following description, given solely by way of non-limiting example, and made with reference to the drawings, wherein:

FIG. 1 is a schematic perspective of an integrating sphere according to the disclosure.

FIG. 2 is a schematic section of the integrating sphere illustrated in FIG. 1 according to the plane II-II of the latter.

FIG. 3 is a partial cutaway perspective of an upper half-body of the integrating sphere illustrated in FIG. 1.

FIG. 4 is a schematic perspective of a socket holding a bulb intended to form a light source equipping the integrating sphere, as illustrated in FIG. 1.

FIG. 5 is a perspective similar to FIG. 4. on which a cover of the socket has been removed so as to show part of the interior.

FIG. 6 is a schematic elevation of a lamp intended to form a light source for the integrating sphere illustrated in FIG. 1.

FIG. 7 is a schematic section of a connection block constituting the socket illustrated in FIGS. 4 and 5.

### DETAILED DESCRIPTION

In certain applications, aspects of the disclosure relate to an integrating sphere used as a light source. Such an integrating sphere comprises at least one access window to the integration chamber from the outside, for the installation of a light source such as an incandescent bulb located inside the integration chamber. The integrating sphere also comprises an access window to the integration chamber, open to the outside, allowing the exit of light radiation. This output window then forms a light source with a uniform apparent light intensity in all directions inside its opening.

When obtaining a high or very high light intensity at the output window is desired, it is necessary to have one or more high-power light sources inside the integration chamber. The dimensions of the integrating sphere then, and more particularly of its integration chamber, are a limiting factor, given the thermal power likely to be dissipated by the light sources placed there, so that it is not possible to reliably and sustainably achieve the high light intensities sought. Indeed, the high temperatures prevailing within the integration chamber with the implementation of multiple very powerful light sources affect the lifespan of said light sources and thus the reliability of the system. High temperatures also affect the internal coating of the integration chamber so that the lifespan and optical performance of this coating are severely impacted.

There is therefore a need for a new type of integrating sphere that enables achieving high or very high light powers while providing satisfactory reliability guarantees.

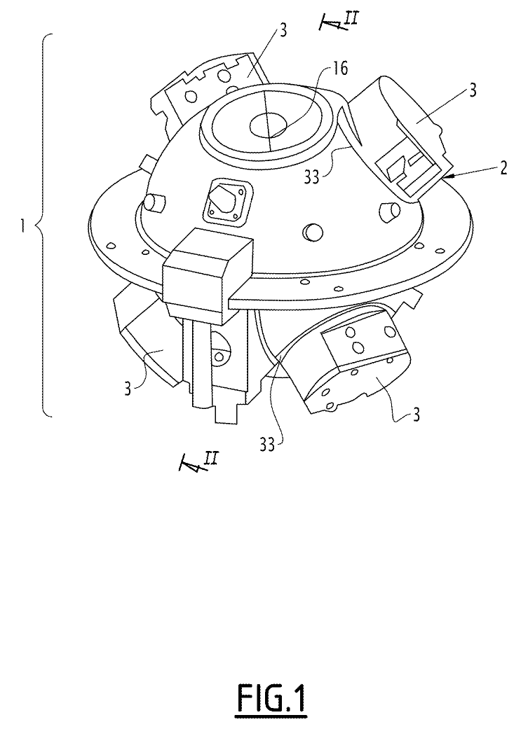

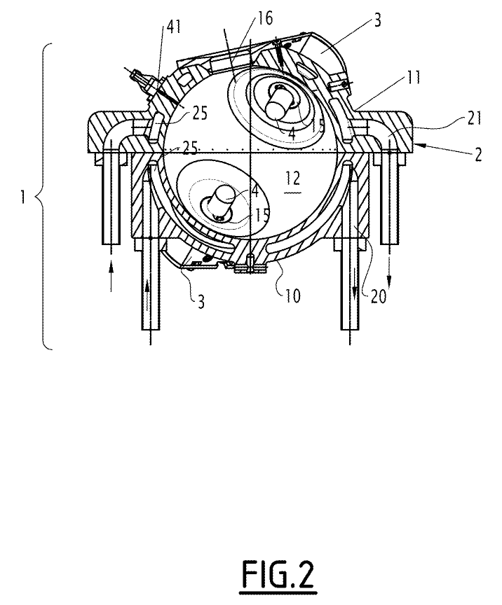

An integrating sphere, as illustrated in FIGS. 1 and 2 and designated as a whole by reference 1, comprises a body 2 equipped with at least one and four sockets 3, in the illustrated example, each provided with a light source formed by a bulb 4.

In the present case, the body 2 comprises two half-bodies, lower 10 and upper 11, which are complementary and together delimit an integration chamber 12. Thus, the lower half-body 10 and the upper half-body 11 form two half-shells that constitute the hollow integrating sphere 1 when assembled.

In the illustrated example, the integration chamber 12 has a spherical or substantially spherical shape, with it understood that it could have another appropriate shape, depending on the applications.

The body 2 comprises at least two and, in the illustrated example, five access windows to the inside of the integration chamber 12, of which only three are visible in FIG. 2. In the present case, four windows 15 are intended for the installation of a bulb 4 constituting a light source, while the fifth window 16 is intended to enable the light emitted by the bulbs 4 to exit after backscattering on the wall of the integration chamber 12.

In this regard, it should be noted that the wall of the integration chamber 12 is covered with a reflective and diffusing coating, adapted to the nature of the light radiation from the light sources 4. Thus, in the case of radiation in the visible spectrum, a white barium sulfate-based paint will be used, for example, while in the case of radiation in the infrared domain, a gold-based coating will be used. The skilled person knows how to adapt the reflective coating to the nature of the light radiation used, so it is unnecessary to further describe the possible variants in the choice of the coating covering the internal surface of the integration chamber 12.

In accordance with a desirable aspect of the disclosure, the body 2 of the integrating sphere comprises at least one cooling channel for the circulation of a heat transfer fluid. In the present case, the body 2 comprises two channels 20 and 21 arranged in the lower half-body 10 and the upper half-body 11, respectively. To enable optimal temperature control within the integration chamber 12 and, more particularly, to evacuate the heat produced by the light sources 4, each channel 20, 21 comprises at least one portion that extends over at least part of the periphery of the integration chamber 12, as shown more particularly in FIG. 2.

The objective is then to maximize the exchange surface between the peripheral wall of the integration chamber 12 and each channel 20, 21, as much as possible. This objective can be achieved in different ways, such as, for example, by creating a network of secondary channels within each channel 20, 21, that extend over a large part of the periphery of the wall of the integration chamber 12, outside the latter. The channels are then made so that the wall thickness separating the inside of each channel 20, 21, from the peripheral face of the integration chamber 12 is as reduced as possible, taking into account the mechanical constraints to which the entire system and, more particularly, the body 2 and its constituent elements must withstand.

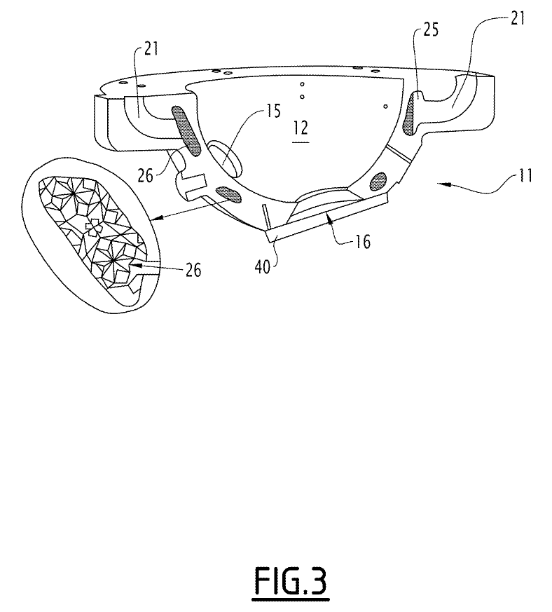

In a preferred embodiment and as visible in FIGS. 2 and 3, each channel 20, 21 comprises a cooling chamber 25 that extends over at least part of the periphery of the corresponding portion of the integration chamber 12. The objective of this cooling chamber 25 is to create a double-skin cooling around the integration chamber 12. Thus, the cooling chamber 25 defines a volume for the circulation of the cooling fluid that has a shape generally similar to that of the peripheral wall of the integration chamber 12. As previously mentioned, the cooling chamber 25 is arranged in each of the corresponding half-bodies 10, 11, so that the thickness of the wall separating the inside of the cooling chamber 25 from the peripheral face of the integration chamber 12 is as reduced as possible, taking into account, of course, the mechanical constraints.

In a preferred but not exclusive embodiment, to increase the exchange surface between the body 2 or the half-bodies 10, 11, that constitute it and the heat transfer fluid circulating therein, the cooling chamber 25 comprises an exchange structure 26, permeable to the heat transfer fluid, connecting the two opposite internal faces of said cooling chamber 25. This exchange structure 26 is made of the same material as the body 2 and, preferably, forms a monobloc assembly with the latter so that the material continuity ensures good thermal conductivity between this exchange structure 26 and the rest of the body 2. The exchange structure 26 can have different shapes, depending on the nature of the heat transfer fluid used in particular. Thus, the exchange structure 26 can be formed by fins connecting the opposite walls of the cooling chamber 25. In the present case, and as shown in the detail of FIG. 3, the exchange structure 26 is formed by a set of prismatic elements constituting a porous structure capable of being traversed by the heat transfer fluid.

To ensure continuity between the exchange structure 26 and the body 2 or the half-bodies 10, 11 that constitute it, the body 2 is preferably manufactured using an additive manufacturing process, also called 3D printing, with materials that have good thermal conductivity such as aluminum, stainless steel, copper or ceramics. Such a manufacturing method also ensures a full sealing of the cooling circuits formed by the channels 20, 21 and the cooling chambers 25.

Thus, in examples, the body 2, or each half-body 10 and 11, has a cooling chamber 25 delimited between an internal skin and an external skin, with the exchange structure 26 that extends between the internal skin and the external skin being made in a single piece of material (i.e. monobloc) with the internal skin and the external skin.

To optimize the cooling of the entire system constituting the integrating sphere and comprising the body 2 equipped with light sources, the disclosure proposes to implement specific sockets 3 to carry and ensure the electrical supply of the lamps 4.

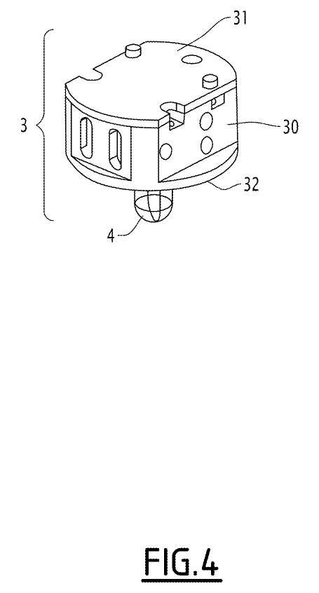

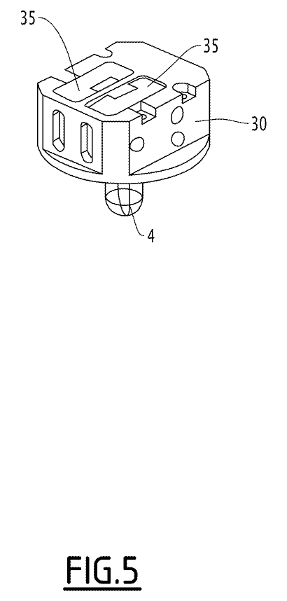

As shown in FIGS. 4 and 5, each socket 3 comprises a socket body 30, closed by a cover 31. At its base, the socket body 30 has a mounting plate 32 that has a shape complementary to that of a mounting base 33 arranged on the body 2 or the corresponding half-body 10 or 11 at each window 15 for the installation of a light source. The complementarity of the plate 32 and the mounting base 33 is designed so that the socket 3 forms a means of closing the integration chamber 12. Of course, the plate 32 and the mounting base 33 are configured to enable a removable adaptation of the socket 3 on the body 2 of the integrating sphere.

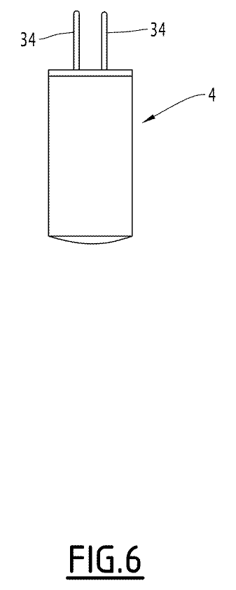

Each socket 3 comprises means for electrically supplying the light source 4 it supports. In the present case and as shown in FIG. 6, each light source 4 is formed by a bulb comprising two straight power pins 34, also called "pins." The supply means then comprise two connection blocks 35, one for each pin 34.

Each connection block 35 is made of an electrically conductive material such as copper, while the socket body 30 of the socket 3 is preferably made of a thermally conductive but electrically insulating material such as an aluminum nitride ceramic.

In examples, the mounting base 33 of the socket 3 is composed of a thermally conductive and electrically insulating material. This feature provides a significant advantage for cooling the sphere as compared to the sockets traditionally used, whose mounting base is not thermally conductive.

Preferably, in operation, the mounting base 33 of the socket 3 is thermally cooled by the integrating sphere 1.

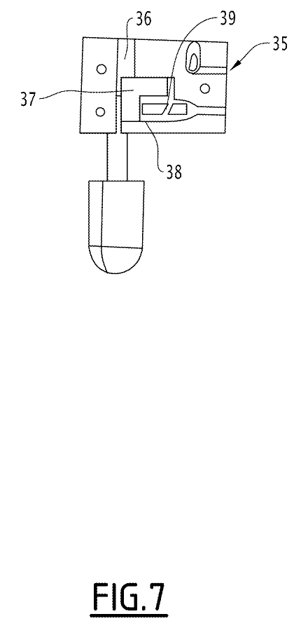

As shown in FIG. 7, each connection block 35 comprises a connection channel 36, intended to receive a power pin 34. The connection channel 36 is equipped with a clamping jaw 37, intended to press the pin 34 against a wall of the channel 36. According to the illustrated example, the clamping jaw 37 is controlled in the clamping position by a spring 38. “Controlled in the clamping position” means that the spring 38 pushes the jaw 37 towards the wall of the channel 36, to clamp the pin 34 when it is there. The spring 38 is complemented by a pressure screw 39, adapted to reversibly immobilize the jaw in the clamping position of the power pin 34 and thus ensure full electrical contact between the latter and the connection block 35.

The implementation of the spring 38 enables facilitating the mounting of the lamp 4 on the socket 3 in that the pressure exerted by the spring enables immobilizing the lamp in the socket before tightening the corresponding screw.

A mounting base 33, using a jaw system comprising a pressure screw 39 and a return spring 38, enables adapting to different types (or spacings) of sockets 3 in particular, unlike commercial mounting bases that require the purchase of specific sockets.

When implementing the integrating sphere 1 and its constituent elements as described above, the sockets 3 are equipped with lamps 4 before the assembly thereof, and then fixed on the body 2 with the interposition of a thermal paste or gasket compatible with vacuum use. This thermal paste or gasket ensures good heat conduction between each socket 3 and the body 2 and thus enables effective heat evacuation from each socket 3 by the cooling circuit of the integrating sphere 1.

It should be noted that such a thermal paste or gasket is preferably implemented at all junction surfaces of the various components of the integrating sphere 1 according to aspects of the disclosure.

As previously indicated, the sockets 3 ensure the closure of the windows 15. It is then possible to control the internal atmosphere of the integration chamber 12 by means of continuous gas injection, for example, and, for this purpose, the body 2 comprises a channel 41, intended to be connected to a unit, not shown, adapted to ensure this management. This internal atmosphere management unit of the integration chamber 12 can comprise a purified gas source, for example, but not exclusively.

When implementing the integrating sphere 1 according to aspects of the disclosure and as described above, the cooling circuit, formed in particular by the channels 20, 21, is connected to a cooling unit, not shown, which ensures the supply and circulation of the heat transfer fluid, which can be of any appropriate liquid or gaseous nature, depending on the applications. The heat transfer fluid is then chosen based on the power and usage conditions.

According to the example described above, the body 2 of the integrating sphere 1 is made in two parts. However, the implementation of additive manufacturing enables envisaging production of this body 2 in a single block.

Of course, various other embodiments of the integrating sphere according to aspects of the disclosure can be envisaged within the scope of the attached claims.

What is claimed is:

1. An integrating sphere comprising a body delimiting an integration chamber, being provided with at least two access windows to the integration chamber from the outside of the body, wherein the body comprises at least one cooling channel for the circulation of a heat transfer fluid.

2. The integrating sphere according to claim 1, wherein the body comprises at least two complementary half-bodies each comprising a part of the integration chamber and at least one cooling channel.

3. The integrating sphere according to claim 1, wherein at least one cooling channel extends inside the body over at least part of the periphery of the integration chamber.

4. The integrating sphere according to claim 1, wherein it comprises at least one cooling chamber connected to the cooling channel, and which extends over at least part of the periphery of the integration chamber.

5. The integrating sphere according to claim 4, wherein the cooling chamber defines a double-skin structure with a wall of the integration chamber.

6. The integrating sphere according to claim 4, wherein the cooling chamber comprises at least one exchange structure, permeable to the heat transfer fluid, connecting two opposite internal faces of the cooling chamber.

7. The integrating sphere according to claim 6, wherein the exchange structure comprises a mesh or porous structure, permeable to the heat transfer fluid.

8. The integrating sphere according to claim 1, wherein the sphere comprises at least one channel for managing the internal atmosphere of the integration chamber.

9. The integrating sphere according to claim 1, wherein the body is made of a thermally conductive material.

10. The integrating sphere according to claim 1, wherein the body is manufactured by additive manufacturing.

11. The integrating sphere according to claim 1, wherein one of the windows is intended for the installation of a light source and in that the body comprises at this window a mounting base for a socket supporting a lamp constituting the light source.

12. The integrating sphere according to claim 11, wherein the socket comprises a body comprising at least two connection blocks each intended to receive a power pin of the lamp.

13. The integrating sphere according to claim 1, wherein it comprises a socket supporting a lamp, this socket being removably adapted to the mounting base.

14. The integrating sphere according to claim 13, wherein the socket comprises a body comprising at least two connection blocks each intended to receive a power pin of the lamp.

15. The integrating sphere according to claim 12, wherein each connection block comprises a connection channel, intended to receive a power pin of the lamp and equipped with a clamping jaw of the pin controlled in the clamping position by a spring complemented by a pressure screw, adapted to reversibly immobilize the jaw in the clamping position of the power pin.

16. The integrating sphere according to claim 14, wherein each connection block comprises a connection channel, intended to receive a power pin of the lamp and equipped with a clamping jaw of the pin controlled in the clamping position by a spring complemented by a pressure screw, adapted to reversibly immobilize the jaw in the clamping position of the power pin.

17. The integrating sphere according to claim 12, wherein the body of the socket is made of a thermally conductive and electrically insulating material.

18. The integrating sphere according to claim 14, wherein the body of the socket is made of a thermally conductive and electrically insulating material.
